(19) United States
(12) Patent Application Publication
(10) Pub. No.: US 2009/0135624 A1
(43) Pub. Date: May 28, 2009

(54) SIDE-EDGE TYPE BACKLIGHT MODULE

(75) Inventors: Kuang-Lung Tsai, Taoyuan Hsien (TW); Tsu-Hua Ai, Taoyuan Hsien (TW); Chung-Liang Kuo, Taoyuan Hsien (TW); Jun-Chang Wang, Taoyuan Hsien (TW); Shue-Liang Lin, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/142,338

(22) Filed: Jun. 19, 2008

(30) Foreign Application Priority Data
Nov. 22, 2007 (TW) 096219747

(51) Int. Cl. F21V 17/00; H01J 1/88

(52) U.S. Cl. 362/613; 362/630; 315/291

(57) ABSTRACT

A side-edge type backlight module includes a first light-emitting unit, a second light-emitting unit, a first high-voltage connector unit and a second high-voltage connector unit. The first light-emitting unit has a first electrode and a second electrode. The second light-emitting unit has a third electrode and a fourth electrode. The fourth electrode is electrically connected to the second electrode of the first light-emitting unit. The first high-voltage terminal is electrically connected to the first electrode of the first light-emitting. The second high-voltage terminal is electrically connected to the third electrode of the second light-emitting unit.

### CROSS REFERENCE TO RELATED APPLICATIONS

This Non-provisional application claims priority under 35 U.S.C. §119(a) on Patent Application No(s). 096219747 filed in Taiwan, Republic of China on Nov. 22, 2007, the entire contents of which are hereby incorporated by reference.

### BACKGROUND OF THE INVENTION

1. Field of Invention

The invention relates to a backlight module and, in particular, to a side-edge type backlight module.

2. Related Art

In comparison with the conventional cathode ray tubes (CRT) displays, the liquid crystal display (LCD) has the advantages of compact size, low power consumption, low radiation and involving manufacturing techniques that are compatible with semiconductor manufacturing processes. Therefore, the LCD has gradually replaced the CRT displays and become the mainstream in the display industry.

The conventional LCD mainly includes an LCD unit and a backlight module. The backlight module can be categorized into the direct type backlight module and the side-edge type backlight module. In either type of backlight module, they all require at least one driving circuit board to drive the light-emitting units therein. The most common light-emitting unit is the cold cathode fluorescent lamp (CCFL). It is driven by the high-voltage driving signal provided by the driving circuit board.

FIG. 1 is a schematic view of a conventional double-lamp side-edge type backlight module. The two lamps 11 are connected to the driving circuit board 13. The two terminals 111, 112 of the lamp 11 are electrically connected to high-voltage wires 12 that can carry high voltages and have connecting terminals 121, 122. The terminal 111 is connected to the high-voltage output terminal V_{H} of the driving circuit board 13 via the connecting terminal 121 of the high-voltage wire 12. The terminal 112 is connected to the ground GND of the driving circuit board 13 via the connecting terminal 122 of the other high-voltage wire 12. In this case, the high-voltage driving signal output by the driving circuit board 13 goes from the high-voltage output terminal V_{H}, the connecting terminal 121, and the high-voltage wire 12 to the lamp 11, thereby driving the lamp 11.

As described hereinabove, each of the lamps requires two high-voltage connecting terminals and two high-voltage wires. When more lamps are used in the backlight module, the number of the above-mentioned elements is doubled or tripled and so is the cost.

### SUMMARY OF THE INVENTION

In view of the foregoing, the invention is to provide a side-edge type backlight module that requires fewer connecting elements and saves the production cost.

To achieve the above, the invention discloses a side-edge type backlight module including a first light-emitting unit, a second light-emitting unit, a first high-voltage connector unit and a second high-voltage connector unit. The first light-emitting unit has a first electrode and a second electrode. The second light-emitting unit has a third electrode and a fourth electrode, which is electrically connected to the second electrode. The first high-voltage connector unit is electrically connected to the first electrode of the first light-emitting unit. The second high-voltage connector unit is electrically connected to the third electrode of the second light-emitting unit.

As mentioned above, the side-edge type backlight module of the present invention utilizes the terminals, lead, or welding technique to electrically connect the second electrode of the first light-emitting unit and the fourth electrode of the second light-emitting unit. Compared with the prior art, the side-edge type backlight module of the present invention only requires one high-voltage connecting terminal and one high-voltage wire for one light-emitting unit. Therefore, the amount of connecting components and the production cost can be reduced.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic view of a conventional double-lamp side-edge type backlight module;

FIG. 2 s a cross-sectional schematic view of a side-edge type backlight module according to an embodiment of the invention;

FIGS. 3A to 3C are schematic views showing the connection of the side-edge type backlight module according to the embodiment of the invention; and

FIG. 4 is a schematic view of the driving signals in the side-edge type backlight module according to the embodiment of the invention.

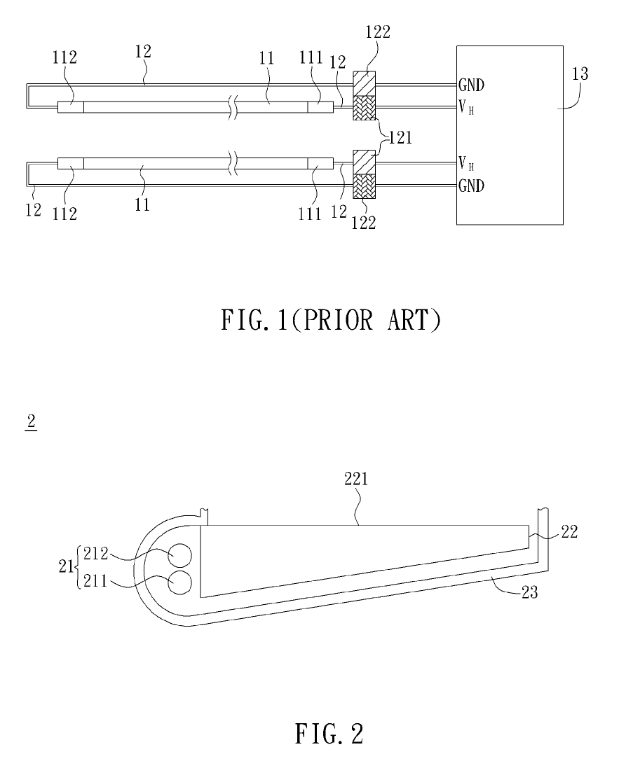

### DETAILED DESCRIPTION OF THE INVENTION

The present invention will be apparent from the following detailed description, which proceeds with reference to the accompanying drawings, wherein the same references relate to the same elements.

As shown in FIG. 2, the side-edge type backlight module 2 according to an embodiment of the present invention includes a light source 21, a light guiding plate 22 and a housing 23. The light source 21 and the light guiding plate 22 are disposed inside the housing 23. The light guiding plate 22 has a light-outputting surface 221. The light source 21 is disposed on the side of the light guiding plate 22 perpendicular to the light-outputting surface 221.

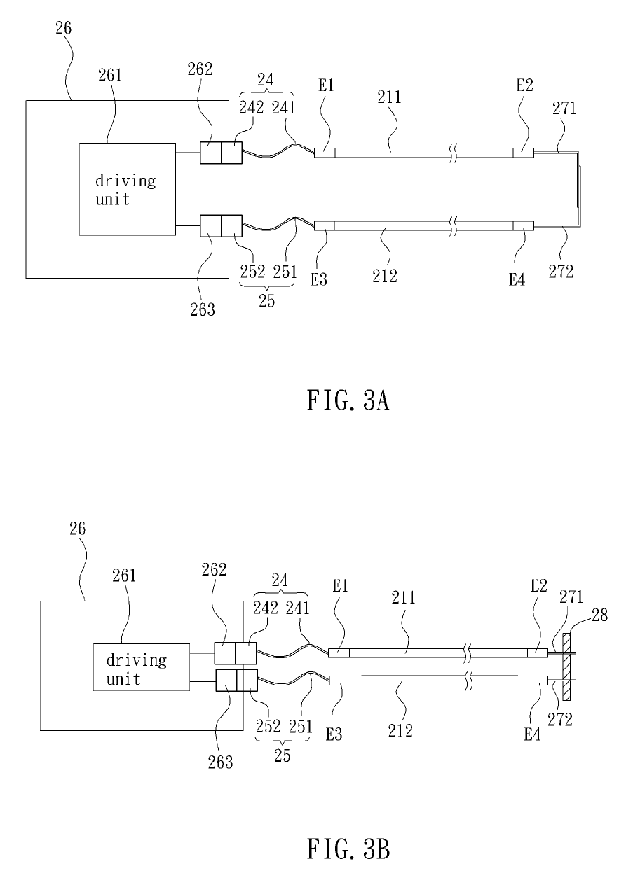

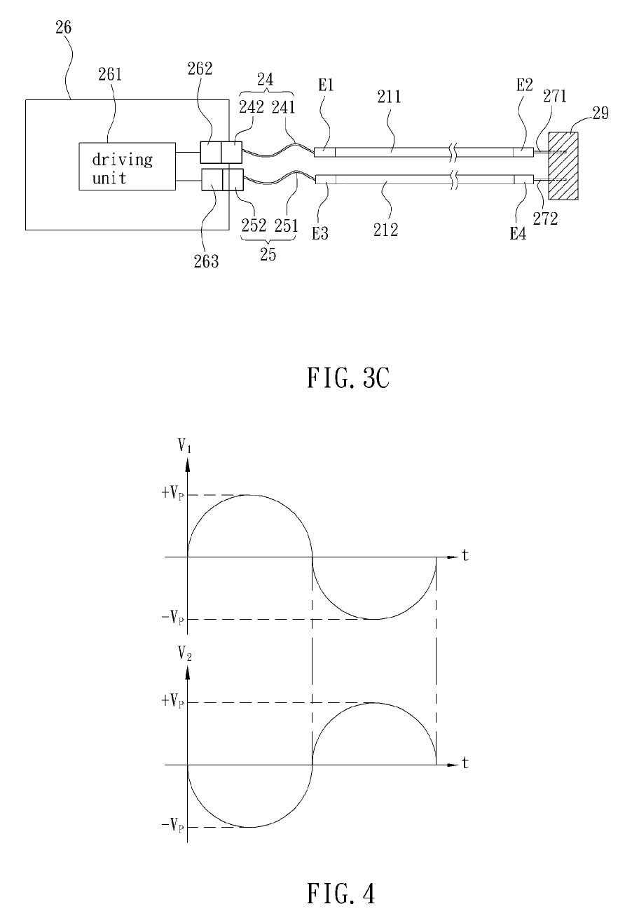

With reference to FIG. 3A, the side-edge type backlight module 2 has a first high-voltage connector unit 24, a second high-voltage connector unit 25 and a driving circuit board 26.

The light source 21 includes a plurality of light-emitting units. In this embodiment, the light source 21 has a first light-emitting unit 211 and a second light-emitting unit 212. They are either a cold cathode fluorescent lamp (CCFL) or an external electrode fluorescent lamp (EEFL).

The first light-emitting unit 211 has a first electrode E1 and a second electrode E2. The second light-emitting unit 212 has a third electrode E3 and a fourth electrode E4. The second and fourth electrodes E2, E4 are electrically connected to each other.

The side-edge type backlight module utilizes terminals, leads, metal soldering or welding technique to electrically connect the second electrode E2 of the first light-emitting unit 211 with the fourth electrode E4 of the second light-emitting unit 212. However, the invention is not limited to these examples. The welding technique includes electric welding and gas welding.

In this embodiment, the second electrode E2 has a first metal wire 271, and the fourth electrode E4 has a second metal wire 272. The first metal wire 271 is connected to the second metal wire 272 by soldering or welding so that the fourth electrode E4 can be electrically connected to the second electrode E2. In this case, the welding technique includes electric welding and gas welding. As shown in FIG. 3A, the first metal wire 271 of the second electrode E2 and the second metal wire 272 of the fourth electrode E4 are bent, followed by soldering or welding to connect them electrically.

The first and second metal wires 271, 272 can also be electrically connected via a terminal.

The first metal wire 271 of the second electrode E2 and the second metal wire 272 of the fourth electrode E4 are electrically connected via a lead 28. Such a connection of the lead 28 with the second electrode E2 and the fourth electrode E4, as shown in FIG. 3B, can be achieved by soldering, welding or some mechanical structure. In this embodiment, the lead 28 is a metal stripe or metal bar.

In addition to the above-mentioned connection methods, the lead 28 can also be replaced by a metal sleeve 29, as shown in FIG. 3C. In particular, the first and second metal wires 271, 272 are both disposed in the metal sleeve 29, and electrically connected to the metal sleeve 29 by soldering or welding.

Referring to FIG. 3A again, the first high-voltage connector unit 24 has a first high-voltage wire 241 and a first high-voltage connecting terminal 242. The second high-voltage connector unit 25 has a second high-voltage wire 251 and a second high-voltage connecting terminal 252. The first high-voltage wire 241 is electrically connected with the first high-voltage connecting terminal 242 and the first electrode E1. The second high-voltage wire 251 is electrically connected to the second high-voltage connecting terminal 252 and the third electrode E3.

The driving circuit board 26 includes a driving unit 261, a third high-voltage connecting terminal 262 and a fourth high-voltage connecting terminal 263. The third high-voltage connecting terminal 262 is electrically connected to a positive high-voltage end of the driving unit 261 and the first high-voltage connecting terminal 242. The fourth high-voltage connecting terminal 263 is electrically connected to a negative high-voltage end of the driving unit 261 and the second high-voltage connecting terminal 252.

Referring to FIGS. 3A and 4, the driving unit 261 generates a driving signal V₁ with a first phase and a driving signal V₂ with a second phase. The driving signal V₁ goes through the third high-voltage connecting terminal 262 and the first high-voltage connecting unit 24 to drive the first light-emitting unit 211. The driving signal V₂ goes through the fourth high-voltage connecting terminal 263 and the second high-voltage connecting unit 25 to drive the second light-emitting unit 212. In this embodiment, the peak values V_{P} and frequencies of the driving signals V₁ and V₂ output by the positive high-voltage end and negative high-voltage end of the driving unit 26, respectively, are the same, whereas their phases differ by 180 degrees.

As forementioned before, the driving signals shown in FIG. 4 can also be applied to the side-edge type backlight module as shown in FIG. 3B or FIG. 3C.

It is to be noted that when used in the double-lamp structure, the side-edge type backlight module 2 only requires two high-voltage connecting terminals (the first high-voltage connecting terminal 242 and the second high-voltage connecting terminal 252) and two high-voltage wires (the first high-voltage wire 241 and the second high-voltage wire 251) to drive both of the first light-emitting unit 211 and the second light-emitting unit 212. In other words, a set of double-lamp structure only requires two high-voltage connecting terminals and two high-voltage wires. When the backlight module requires more double-lamp structures, the number of required high-voltage connecting components and the cost can be greatly reduced.

In summary, the side-edge type backlight module of the present invention utilizes the terminals, lead, or welding technique to electrically connect the second electrode of the first light-emitting unit and the fourth electrode of the second light-emitting unit. Compared with the prior art, which requires two high-voltage connecting terminals and two high-voltage wires for one light-emitting unit, the side-edge type backlight module of the invention only requires one high-voltage connecting terminal and one high-voltage wire for one light-emitting unit. Therefore, the present invention can reduce the amount of connecting components and thus the production cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module comprising:
a first light-emitting unit having a first electrode and a second electrode;
a second light-emitting unit having a third electrode and a fourth electrode, wherein the fourth electrode is connected to the second electrode;
a first high-voltage connector unit electrically connected to the first electrode; and
a second high-voltage connector unit electrically connected to the third electrode.

2. The backlight module of claim 1, wherein the fourth electrode is connected to the second electrode by a terminal, lead, metal or sleeve.

3. The backlight module of claim 1, wherein the fourth electrode is connected to the second electrode by soldering, welding, electric welding or gas welding.

4. The backlight module of claim 1, wherein the second electrode has a first metal wire, and the fourth electrode has a second metal wire.

5. The backlight module of claim 4, wherein the first and second metal wires are electrically connected to each other through a terminal.

6. The backlight module of claim 4, wherein the first and second metal wires are connected to each other through a lead or a metal sleeve by soldering, welding, electric welding or gas welding.

7. The side-edge type backlight module of claim 4, wherein the first metal wire of the first electrode and the second metal wire of the fourth electrode are bent and electrically connected by soldering, welding, electric welding or gas welding.

8. The backlight module of claim 1, further comprising a driving circuit board electrically connected to the first high-voltage connector unit and the second high-voltage connector unit.

9. The backlight module of claim 8, wherein the first high-voltage connector unit has a first high-voltage wire and a first high-voltage connecting terminal connected to the first high-voltage wire.

10. The backlight module of claim 9, wherein the first high-voltage wire is electrically connected to the first electrode.

11. The backlight module of claim 9, wherein the first high-voltage connecting terminal is electrically connected to a third high-voltage connecting terminal of the driving circuit board.

12. The backlight module of claim 8, wherein the second high-voltage connector unit has a second high-voltage wire and a second high-voltage connecting terminal connected to the second high-voltage wire.

13. The backlight module of claim 12, wherein the second high-voltage wire is electrically connected to the third electrode.

14. The backlight module of claim 12, wherein the second high-voltage connecting terminal is electrically connected to a fourth high-voltage connecting terminal of the driving circuit board.

15. The backlight module of claim 14, wherein the driving circuit board further comprises a driving unit electrically connected to the third high-voltage connecting terminal and the fourth high-voltage connecting terminal.

16. The backlight module of claim 15, wherein the driving unit generates an AC driving signal with a first phase and an AC driving signal with a second phase, both of which are output respectively through the third high-voltage connecting terminal and the fourth high-voltage connecting terminal.

17. The backlight module of claim 16, wherein the AC driving signals with the first phase and the second phase have the same peak value and frequency, and the first phase and the second phase differ by 180 degrees.

18. The backlight module of claim 1, wherein each of the first light-emitting unit and the second light-emitting unit is a cold cathode fluorescent lamp or an external electrode fluorescent lamp.

19. The backlight module of claim 1, further comprising a light guiding plate, wherein the first light-emitting unit and the second light-emitting unit are disposed on one side of the light guiding plate that is perpendicular to a light-outputting surface.
